(19) United States
(12) Patent Application Publication
(10) Pub. No.: US 2018/0188204 A1
(43) Pub. Date: Jul. 5, 2018

(54) Use of charged quinine sulfate or other precursors or derivatives of quinine alkaloids in visualization of nucleic acids

(71) Applicant: SYLVESTER TUMUSIIME, SAINT ROSE, LA (US)

(72) Inventor: SYLVESTER TUMUSIIME, SAINT ROSE, LA (US)

(21) Appl. No.: 15/396,676

(22) Filed: Jan. 1, 2017

(51) Int. Cl. G01N 27/447; G01N 21/64

(52) U.S. Cl. CPC G01N 27/44726; G01N 2021/6439; G01N 21/6428; G01N 27/44747

(57) ABSTRACT

The present invention seeks to solve the problem of using a carcinogenic mutagen—ethidium bromide; to visualize nucleic acids in molecular biology and other related fields by intercalation of nucleic acids with ethidium bromide and exposure to UV light. The invention is a formulation containing a fluorophore; quinine sulfate or any such appropriate precursor or derivative of quinoline alkaloids at appropriate protonation and nucleic acid binding state that enables nucleic acid binding, electrophoresis and visualization of nucleic acid-fluorophore conjugate thereby eliminating the use of ethidium bromide.

### BACKGROUND OF THE INVENTION

In molecular biology and related fields requiring analysis of nucleic acids, ethidium bromide is a routinely used nucleic acid stain. Ethidium bromide binding to nucleotides is not governed by base composition or by the denaturation of DNA but is rather influenced by variability in salt concentration; particularly magnesium ions which act to reduce the interaction strength¹ (Non Patent Literature 1). Ethidium bromide binding to nucleotides occurs at a frequency of one molecule for every four to five nucleotides. The absorption maxima of ethidium bromide aqueous solutions at 210 nm and 285 nm (corresponding to ultraviolet light) and the resulting emission spectrum at 605 nm² (Non Patent Literature 2), combined with its ability to intercalate between nucleic acid base pairs is the reason why it is widely used as a detection and visualization mechanism for observing nucleic acids. This detection is typically performed following gel electrophoresis of nucleic acids and exposure of said gels to ultraviolet light. Unfortunately, the nucleic acid intercalating property of ethidium bromide has mutagenic properties³ (Non Patent Literature 3) that impart a carcinogenic potential if absorbed by humans^{4,5} (Non Patent Literature 4 & 5). As a result, various alternatives to ethidium bromide have been documented⁶⁻²⁸ (Non Patent Literature 6-28). One alternative to ethidium bromide that has the ability to associate with DNA and fluoresce is quinine or other derivatives and precursors of quinoline alkaloids. However, these molecules have not been assayed as potential replacements for ethidium bromide in nucleic acid staining.

Quinine is an alkaloid derived from the bark of Cinchona tree species²⁹ (Non Patent Literature 29), and it belongs to a family of quinoline alkaloids that include quinidine, cinchonidine, and cinchonine. The general structure of the quinolone alkaloids consists of a central hydroxyl group plus quinolone and quinuclidine rings²⁹ (Non Patent Literature 29). No naturally dimeric Cinchona alkaloids exist and dimers are typically the products of industrial exploitation of reactive sites in the Cinchona alkaloids²⁹ (Non Patent Literature 29). The dimeric alkaloid molecules accumulate additional functional groups within a limited space. The dimerization often is performed at the central 9-OH group via etherification and esterification reactions, and the quinuclidine N−1 atom²⁹ (Non Patent Literature 29). Further modification of Cinchona alkaloids has been achieved via organocatalytic reactions like dichlorination³⁰ (Non Patent Literature 30), fluorination³¹ (Non Patent Literature 31), opening of cyclic anhydrides³² (Non Patent Literature 32), Mannich-type reactions³³ (Non Patent Literature 33), conjugation³⁴ (Non Patent Literature 34), cyanation of ketones³⁵ (Non Patent Literature 35), cyclopropanation³⁶ (Non Patent Literature 36), dihydroxylated alkaloids³⁷ (Non Patent Literature 37), iodination³⁸ (Non Patent Literature 38), etherification to obtain dimeric alkaloid alkyl ethers³⁹⁻⁴¹ (Non Patent Literature 39-41), esterification⁴² (Non Patent Literature 42), 9-carbon and 9-sulphur-linked dimerization^{43,44} (Non Patent Literature 43 & 44), formation of N1-Quarternary ammonium salts^{45,46} (Non Patent Literature 45 & 46), derivatives of 3-Vinyl group coupling⁴⁷ (Non Patent Literature 47), quinolone ring modification⁴⁸ (Non Patent Literature 48), double-bridged dimerization⁴⁹ (Non Patent Literature 49) and nucleophilic substitution⁵⁰ (Non Patent Literature 50).

Quinine and its derivatives have been and continue to be used as antimalarial drugs^{29,51,52} (Non Patent Literature 29 (and Patent Literature 51, 52), in the treatment of chronic bronchitis, asthma and other chronic obstructive respiratory diseases⁵³ (Patent Literature 53), the treatment of rhinitis, post-cold rhinitis, chronic trachitis urinary incontinence, other urological disorders and digestive disorders⁵⁴ (Patent Literature 54), as an antitumor drug⁵⁵ (Non Patent Literature 55), preventing atherosclerosis⁵⁶ (Non Patent Literature 56). The mechanism of action as an antimalarial includes reduction of oxygen intake, disruption of DNA replication and transcription via hydrogen bonding and DNA intercalation that occurs with equal affinity across all nucleotides⁵⁷ (Non Patent Literature 57).

Surprisingly, while having similar DNA binding abilities as ethidium bromide without the associated carcinogenic risk to humans; quinine which is strongly fluorescent with excitation wavelengths of 250 nm and 350 nm and a fluorescence emission at 450 nm (indigo light)⁵⁸ (Non Patent Literature 58) has not been utilized as a fluorescent dye for nucleic acids. While ethidium bromide poses a mutagenic threat in low doses, quinine in the form of quinine sulfate has only been found to have deleterious effects typically following acute and intentional overdoses. Such overdoses can lead to temporal ocular toxicity⁵⁹ (Non Patent Literature 59), non-fatal hemolytic-uremic syndrome⁶⁰ (Non Patent Literature 60), non-fatal immune thrombocytopenia with hemolytic uremic syndrome (HUS)⁶¹ (Non Patent Literature 61), auditory symptoms, gastrointestinal disturbances, vasodilation, and sweating⁶² (Non Patent Literature 62). Therefore, quinine sulfate and potentially other precursors and derivatives of quinoline alkaloids are likely safer alternatives to ethidium bromide in the staining of nucleic acids.

### BRIEF SUMMARY OF THE INVENTION

### Technical Problem

The present invention seeks to provide a fluorophore formulation to be used for safely detecting nucleic acid polymers that have been amplified by any such common methods typically used by researchers, clinical labs and any other such persons that perform studies on nucleic acid polymers that contains quinine and/or precursors and derivatives of quinoline alkaloids and other molecules required for stabilization of nucleic acid-fluorophore interaction and fluorophore charged state. This invention will eliminate the current expenses and health risks associated with detection of nucleic acid polymers using ethidium bromide as the fluorophore of choice.

### Solution to the Problem

The present invention provides a novel pre-mixed chemical admixture or formulation useful for the detection of nucleotides of interest in a fluid sample. Said admixture comprising; (a) fluorophore at specific pH/protonation state capable of absorbing an initial wavelength of exciting energy, (b) said fluorophore being able to emit a portion of the absorbed initial wavelength of exciting energy as radiated energy, (c) said admixture optimized to allow for binding of fluorophore to nucleotide polymers (nucleic acids) using specific additions intended for the said purpose, (d) said admixture is part of a kit containing pre-mixed solutions at appropriate concentration and with instructions for correct use and disposal.

The present invention also provides a method for detecting nucleotide polymers comprising the following steps: (a) addition of fluorophore-nucleotide polymer binding enhancer to enhancer solution, (b) pre-mixing of fluorophore solution at unique pH/protonation state with enhancer solution to create stock solution at specific concentration, (c) pre-mixing of nucleotide polymer solution obtained from polymerase chain reaction or any other appropriate source with said stock solution and allowing for period of fluorophore-nucleotide polymer association, (d) electrophoresis-based separation of said fluorophore-nucleotide polymer complex in an agarose- or polyacrylamide-based gel separation system for appropriate period, (e) exposure of said agarose- or polyacrylamide-based gel system to appropriate emission source, (f) capture of fluorescence from fluorophore-nucleotide polymer complex with an appropriate detection device and storage of an image of the fluorescence in an appropriate manner for further analysis.

### Advantages of the Invention

The present invention enables a user to safely and easily observe size-fractionated nucleic acids in the presence of light of appropriate wavelength in a manner that eliminates the use of a commonly used stain—ethidium bromide; which is a known mutagen and carcinogen.

### BRIEF DESCRIPTION OF DRAWINGS

FIG. 1(a) is a 2D structure of quinine in its non-charged form

FIG. 1(b) is a 2D structure of quinine in its charged form

FIG. 2 is an illustration of an agarose- or polyacrylamide-gel with fluorophore-nucleic acid binding enhancer and containing a nucleic acid with intercalated fluorophore being exposed to excitation wavelength and releasing emission wavelength to capture device.

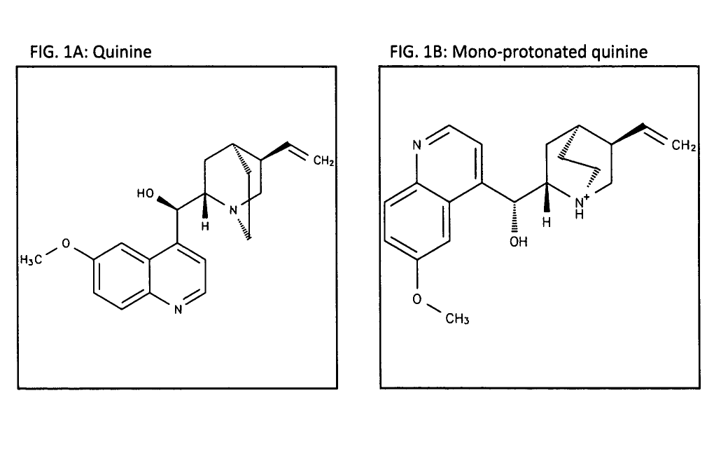

### DETAILED DESCRIPTION OF THE INVENTION

The present invention relates to the detection of nucleic acids using a non-mutagenic, fluorophore-based detecting reagent that can be associated with nucleic acids (obtained from variable sources) and immobilized within proprietary agarose- or polyacrylamide-based gel systems that are core inclusions of the invention; being offered as part of the invention as components of a kit. Said detection will follow exposure of the said gel systems to excitation wavelengths of 250 nm and or 350 nm. The invention is unique in that individual or combinations of members of a known family of fluorogenic substances—precursors and derivatives of quinoline alkaloids as stated in section [0002] are formulated with a metal-ion chelating agent such as but not limited to EDTA (ethylenediaminetetraacetic acid) at appropriate concentrations and with a protonator agent to attain unique protonation levels or no protonator in some formulations. Under such conditions afforded by the aforementioned formulations, introduction of nucleic acids at appropriate concentrations to pre-mixed formulations allow for an enhanced intercalation behavior between said formulation containing fluorophore and adjacent nucleic acid base pairs. Enhanced intercalation interaction is taken advantage of, for example in size-fractionation based electrophoresis of nucleic acid-fluorophore conjugates in proprietary polyacrylamide or agarose gels modified to enhance and maintain intercalation between non-mutagenic fluorophore-based detecting reagent and nucleic acids. Therefore, this invention can take full advantage of the principles of fluorescence spectroscopy whereby a fluorophore absorbs light of a given wavelength and subsequently emits light at a longer wavelength that is captured. It is emphasized that in addition to the provision of non-mutagenic fluorogenic precursors and derivatives of quinoline alkaloids of appropriate protonation and nucleic acid intercalation capacity, the invention is also made unique in that the medium of electrophoresis (agarose or polyacrylamide gel) included as part of a nucleic acid detection kit is optimized to ensure (a) sustained appropriate protonation of said fluorophores and (b) sustained intercalation between fluorophore and nucleic acid.

There are four elements that are essential to the detection of nucleic acids in this invention. The elements include: (a) a non-mutagenic fluorophore-based detecting reagent of correct protonation and nucleic acid binding efficiency, (b) a polyacrylamide- or an agarose-gel-based size fractionation slab with fluorophore-protonation-stabilization inclusions and non-mutagenic fluorophore-nucleic acid intercalation enhancers, (c) a means of introducing light energy of appropriate wavelength to excite said non-mutagenic fluorophores, and (d) a means for detecting fluorescent light from said excited molecules of non-mutagenic fluorophore intercalated with nucleic acid within a polyacrylamide- or an agarose-gel-based size fractionation slab.

The nucleic acids that would be amenable to the said methodology include all manner of artificial or naturally occurring nucleic acids obtained by common extraction methods, enzyme-based restriction digests or by amplification using commonly used techniques, double-stranded nucleic acids, single-stranded nucleic acids, and hybrids of DNA-RNA complexes. Typically, prior amplification of the said nucleotides will be performed by methods including but not limited to Polymerase Chain Reaction (PCR), Ligase Chain Reaction (LCR), Strand Displacement Amplification (SDA), Rolling Circle Amplification (RCA), Cycling Probe Technology (CPT), Q-Beta Replicase Amplification, Isothermal and Chimeric primer-initiated Amplification of Nucleic Acids (ICAN), Loop-Mediated-Isothermal-Amplification of DNA (LAMP), Nucleic acid Sequence-based Amplification (NASBA) and Transcription mediated amplification method (TMA).

The method of association between the nucleic acids and the non-mutagenic fluorophore-based detecting reagent may be performed using variable approaches including but not limited to; pre-mixing an optimized (optimized—in this instance and future mentions refers to a non-mutagenic, fluorophore-based detecting reagent that has been pre-mixed to attain appropriate protonation, and reconstituted with reliable nucleic-acid-binding enhancing agent and appropriate visualization agent) solution of non-mutagenic fluorophore-based detecting reagent with nucleic acid of interest in an appropriate container; for example a microtubule composed of variable materials including but not limited to: plastic, soft glass or Pyrex glass to attain a working solution prior to introduction into an agarose- or polyacrylamide-based electrophoretic system to be exposed to an electric potential resulting in size fractionation of the nucleic acid-non-mutagenic fluorophore complex. Concentrations of the non-mutagenic fluorophore being determined with the aid of already existing detection apparatus^{63,64} (Patent Literature 63 & 64).

The non-mutagenic fluorophore herein is a substance that will absorb light of a given wavelength and emit light of a longer wavelength. This non-mutagenic fluorophore will also have the ability to bind to nucleic acids. Examples of such non-mutagenic fluorophores include; optimized precursors and derivatives of quinoline alkaloids such as quinine, quinidine, cinchonidine and cinchonine, dimeric alkaloid molecules, quinuclidine, dechlorinated forms of such alkaloids, fluorinated forms of such alkaloids, propanated of such alkaloids, such alkaloids that have undergone reactions such as: Mannich-type reactions, conjugation, cyanation of ketones, cyclopropanation, dihydroxylation, iodination, etherification to obtain dimeric alkaloid alkyl ethers, esterification, 9-carbon and 9-sulphur-linked dimerization, formation of N1-Quarternary ammonium salts, derivatives of 3-Vinyl group coupling, quinolone ring modification, double-bridged dimerization and nucleophilic substitution.

Observing Non-Mutagenic Fluorophores Associated with Electrophoresed Nucleic Acids

Commonly used commercial or “home-made” instruments will form the basis by which excitation energy will be applied to the size-fractionated nucleic acids that are intercalated with non-mutagenic fluorophores to cause non-mutagenic fluorophore attainment of excitation energy state and subsequent emission of longer wavelength of light. Same instruments may also form a means of detecting the emitted longer wavelength of light; the amount of emitted light detected being a function of either the levels of intercalated non-mutagenic fluorophore associated with nucleic acid and/or amount of nucleic acid associated with intercalating non-mutagenic fluorophore.

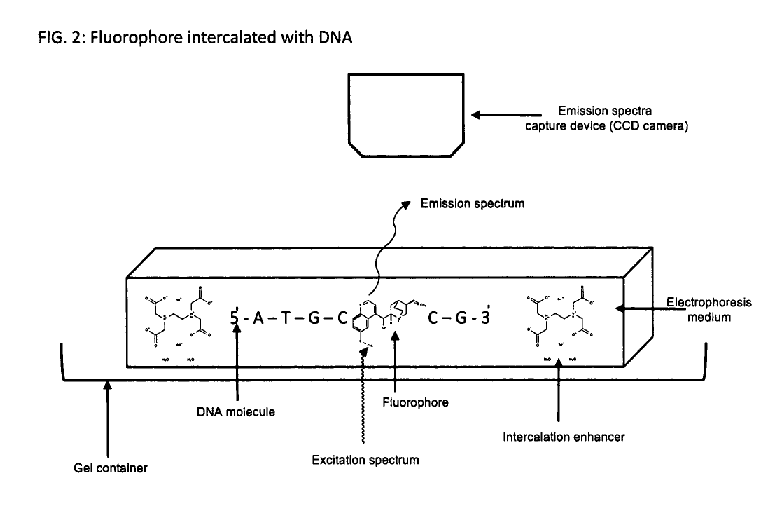

FIG. 2 illustrates the exposure of non-mutagenic fluorophore at correct protonation state intercalated within nucleic acids of interest fractionated in a proprietary agarose- or polyacrylamide gel containing appropriate intercalation-enhancing component and exposed to light wavelength(s) capable of exciting said fluorophores. Excitation wavelengths of 250 nm and 350 nm are emitted from a light source towards proprietary agarose- or polyacrylamide gel with fractionated nucleic acids intercalated with non-mutagenic fluorophore. The gel is supported by a container capable of allowing transmittal of said excitatory wavelengths so as to allow for impingement of targeted non-mutagenic fluorophore. Upon impingement of targeted non-mutagenic fluorophore, fluorescence emission at 450 nm (indigo light) occurs and is detected by a CCD camera with appropriate filter to allow for imaging of fluorescence.

The invention claimed is:

1. A process of visually detecting nucleic acids utilizing a method composed of the following steps: (a) directly exposing nucleic acids to a formulation of quinine sulfate fluorophore (or any such precursor or derivative of the class of quinoline alkaloids derived from naturally occurring or artificial sources with definable light absorption and light emission spectra which absorbs exciting light energy of specific wavelength(s) and emits a portion of exciting wavelength(s) as light of second wavelength(s) with appropriate protonation, metal-ion chelating, and background fluorescence depleting properties so as to enable stable association between nucleic acids and any quinoline alkaloid or it's precursor or derivative (for example quinine sulfate) and elimination of background fluorescence, (b) following exposure of nucleic acids to fluorophore formulation with size separation of nucleic acids associated with said quinoline alkaloid derivative or precursor using commonly used techniques including but not limited to: agarose- or polyacrylamide-based gel electrophoresis, (c) following said size separation of nucleic acid-quinoline alkaloid fluorophore conjugate with exposure to appropriate excitation wavelength(s) so as to cause fluorescence of quinoline alkaloid associated with nucleic acid(s), visualization and capture of fluorescent light image from quinoline alkaloid-nucleic acid conjugate using appropriate means and storage of such images for future analysis.

2. A process of visually detecting nucleic acids as described above with the distinct difference that interaction between nucleic acid and appropriate quinoline alkaloid (including derivatives and precursors of said quinoline alkaloids) occurs during migration of nucleic acids through electrophoresis media whereby derivatives or precursors of quinoline alkaloid(s) fluorophores are incorporated into the electrophoresis media (including agarose or polyacrylamide gel media and associated buffers) thereby causing nucleic acids to associate with said quinoline alkaloid(s) as they migrate through the electrophoresis media during the size fractionation process with subsequent visualization techniques as described previously in claim 1 being applicable.

3. A process of detecting nucleic acids that is a combination of both claims (1 and 2) above whereby, interaction between appropriate quinoline alkaloid(s) (including derivatives and precursors of said quinoline alkaloids) and nucleic acids occurs prior to the electrophoresis process as described in claim 1 and also during the electrophoresis process as described in claim 2 with subsequent visualization techniques as described previously in claim 1 being applicable.
